(19) United States
(12) Patent Application Publication
(10) Pub. No.: US 2017/0344572 A1
(43) Pub. Date: Nov. 30, 2017

(54) PERSONALIZED CONTENT-BASED RECOMMENDATION SYSTEM WITH BEHAVIOR-BASED LEARNING

(71) Applicants: Bret Edward Peterson, Lafayette, CA (US); Ashish Gupta, Sunnyvale, CA (US); Amar Arsikere, Mountain View, CA (US)

(72) Inventors: Bret Edward Peterson, Lafayette, CA (US); Ashish Gupta, Sunnyvale, CA (US); Amar Arsikere, Mountain View, CA (US)

(73) Assignee: Google Inc., Mountain View, CA (US)

(21) Appl. No.: 12/362,464

(22) Filed: Jan. 29, 2009

(51) Int. Cl. G06F 17/30

(52) U.S. Cl. CPC G06F 17/30112

(57) ABSTRACT

A system and method provides recommendations of documents to a user of a document corpus. Document features are extracted and assigned weights, and a profile is likewise created for users. Documents are scored with respect to a given user based at least in part on the document features and the user's profile. The document scores may be adjusted to reflect organizational goals, such as promoting recommendation of newer documents. Based on the scores, recommendations are determined for a given user by identifying the top scores for that user and presented to the user in one of a variety of manners, such as within a web-based user interface, or via email. Interactions of the users with recommendations may be monitored and the recommendations updated accordingly.

### BACKGROUND

### 1. Field of Art

This invention relates generally to computer-implemented knowledge management systems and more specifically to computer systems that recommend to users of documents in document corpora.

### 2. Description of the Related Art

Current computing systems make available vast quantities of digital documents, such as articles, technical talks, Wiki pages, slide shows, and the like. The sheer quantity of available data can make it difficult for users to locate the documents that are most pertinent to their particular interests. Recommendation systems address this problem by presenting the users with a selected set of documents chosen based on some prior knowledge of the user's interests.

However, conventional recommendation systems have a number of shortcomings. For example, many conventional systems rely on domain-specific knowledge, such as customer habits regarding the purchase of movies. This places a great burden on the creator of the system to discover such knowledge and to design a custom recommendation system based on that knowledge, and does not permit an administrator to define corpora (i.e., distinct sets of documents) in a straightforward manner. Other conventional systems, such as many of those oriented towards retail sales, use social networking techniques (e.g., collaborative filtering), which rely on data about the interactions of other users with the various documents to infer the documents in which a particular user would be interested. However, the effectiveness of this technique is a function of the amount of the data on the interactions of other users, and thus systems with a small corpus or few users may not be able to beneficially employ social networking techniques.

### SUMMARY

Disclosed is a system and method for providing recommendations of documents to a user of a document corpus—i.e., a particular collection of documents, such as those relating to technical talks, books on science, and the like. In some organizational environments, there can be a number of distinct corpora, and each is administrable by a corpus administrator. In one embodiment, the corpora are further grouped according to a domain to which they belong. The present invention is of particular applicability where the number of documents and users of a given corpus is sufficiently small to be managed by a corpus administrator, or where there are a number of distinct corpora with which users of a single organization interact differently. These are scenarios in which conventional recommendation systems have low utility.

In one embodiment, document features are extracted and assigned weights, and a profile is likewise created for the various users. Then, the documents are scored with respect to a given user based at least in part on the document features and the user's profile. The document scores are adjusted based on organization-specific information to reflect organizational goals, such as promoting recommendation of newer documents. Based on the scores, recommendations are determined for a given user by identifying the top scores for that user and the recommendations presented to the user. In one embodiment, recommendations are provided within a web-based user interface; in another they are provided via email; in another they are provided as an RSS feed; in still another they are provided as gadgets or frames embedded within other applications. Interactions of the users with recommendations are monitored and the recommendations updated accordingly.

In one embodiment, a computer-implemented method presents to a user selected portions of an organization's corpora, the corpora comprising documents, the method being carried out by a processor configured to determine a set of weighted terms for each of a plurality of the documents, to construct a user profile including user interest areas, to calculate a score for each of the plurality of the documents based on correlation between the weighted terms and the user profile, to adjust the calculated scores based at least in part on rules specified by the organization, and to present the adjusted and scored items to the user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

These and other features of the invention's embodiments are more fully described below. Reference is made throughout the description to the accompanying drawings, in which:

FIG. 1 is a high-level block diagram illustrating a recommendation system for providing recommendations as described herein.

FIG. 2 illustrates in more detail the components of the recommendation logic processor 115 of FIG. 1.

FIG. 3 is a flowchart illustrating the process of providing recommendations, according to one embodiment.

FIG. 4 illustrates a user interface for displaying and interacting with recommendations.

FIGS. 5A-D illustrate user interfaces for administration of various aspects of the recommendation system 110 of FIG. 1.

FIG. 6 illustrates a general purpose computer for use in implementing recommendation logic processor 115 of FIG. 1.

### DETAILED DESCRIPTION

### System Architecture

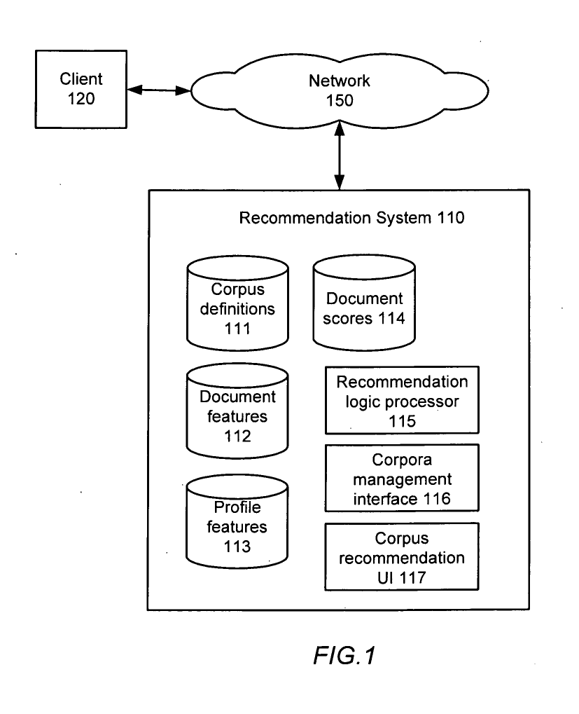

FIG. 1 is a high-level block diagram illustrating a recommendation system 110 for providing the recommendations described herein. Also illustrated are a client computer system 120 used to interact with and/or receive recommendations from the recommendation system 110, as well as a network 150 facilitating communications between the client 120 and the recommendation system 110.

The recommendation system 110 comprises a corpus definitions database 111, which defines each corpus in the system. In one embodiment, a corpus has a name, a set of associated documents, and (optionally) a set of associated users. As used herein, a “document” is a digital representation of information. A word processing file is a common example, but documents include many other things as well, such as digital representations of calendared events (e.g. a talk scheduled for a particular place at a particular time). The associated documents need not be stored on the recommendation system 110 itself; rather, in one embodiment only identifiers (e.g., URLs, path and file names) of the documents themselves need be stored—the data for the documents can be stored on the recommendation system 110, on systems available on a network (e.g., 150) that is local to the recommendation system 110, or on a remote system. In one embodiment, the associated users are represented by identifiers, such as operating system user IDs, of users interested in documents pertaining to that particular corpus. The documents for a given corpus need not be all of the same operating system file type, e.g. a text file or presentation file for a particular presentation application software, but rather can represent the conceptual category of the corpus. For example, in an exemplary embodiment one corpus is named “Technical Presentations,” has a set of 20 associated technical presentations in formats such as ADOBE PDF, Microsoft PowerPoint, word processing formats, event announcements and the like, and has two hundred associated users.

In one embodiment, the corpora are further grouped into domains. For example, an organization administering the recommendation system 110 creates individual domains for each organization that wishes to obtain its own personalized access to the recommendation system 110. The implementation for this embodiment is similar to that described above, with the addition of an association between a corpus and a domain.

A document features repository 112 stores a set of features for each document of the various corpora defined by corpus definitions repository 111. Features of a document represent its concepts, and in one embodiment consist of words and multi-word phrases (“n-grams”). In one example, a document on fishing has associated with it in the features repository 112 the set of terms “salmon”, “fly”, “reel”, “rod”, and “fishing vessel”, with each having an associated value (also referred to as a “weight”) quantifying how relevant the term is to the document. Features of a document could be present in the document itself, could be derived from a user-specified label, or could represent a category to which the document was assigned (e.g. “technical presentations”), for example. In one embodiment, the terms are chosen from a discrete set of possible terms, such as a set of 50,000 terms known to be useful in characterizing a document for search and recommendation purposes. As with other data storage repositories described below, the document features repository 112 is implemented in a conventional manner, such as a table of a conventional relational database management system, a text file, or a specialized binary file. Other manners of implementing repository 112 will be known to one of skill in the art.

A profile features repository 113 stores features, such as terms, associated with users. In one embodiment, each user has an associated profile, the profile storing terms chosen from the same set of possible terms as for the document features repository. The terms represent the interest areas of the user, each having an associated weight quantifying the relevance of the term to the user. As described further below, the terms and their weightings are derived from sources such as documents associated with the user, areas of interest explicitly entered by the user, and user interactions with recommended documents.

A document scores repository 114 stores scores for the various documents identified in the corpus definitions repository 111, each score quantifying the relevance of a given document to a given user. In one embodiment, the score is calculated based at least in part on a function of a profile for the user and the document features for the document.

Recommendation logic processor 115, as described further below, is a subsystem that determines which documents are most relevant to a given user, and provides a list of the recommended documents to the user.

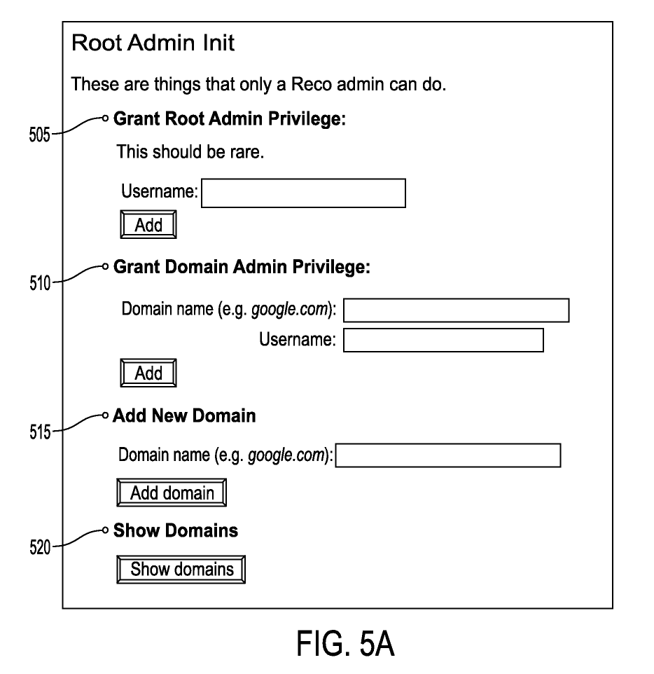

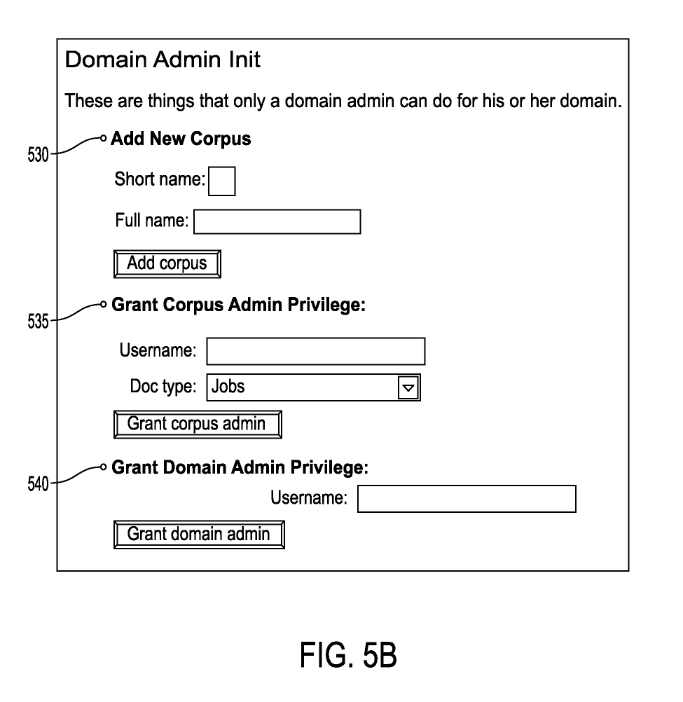

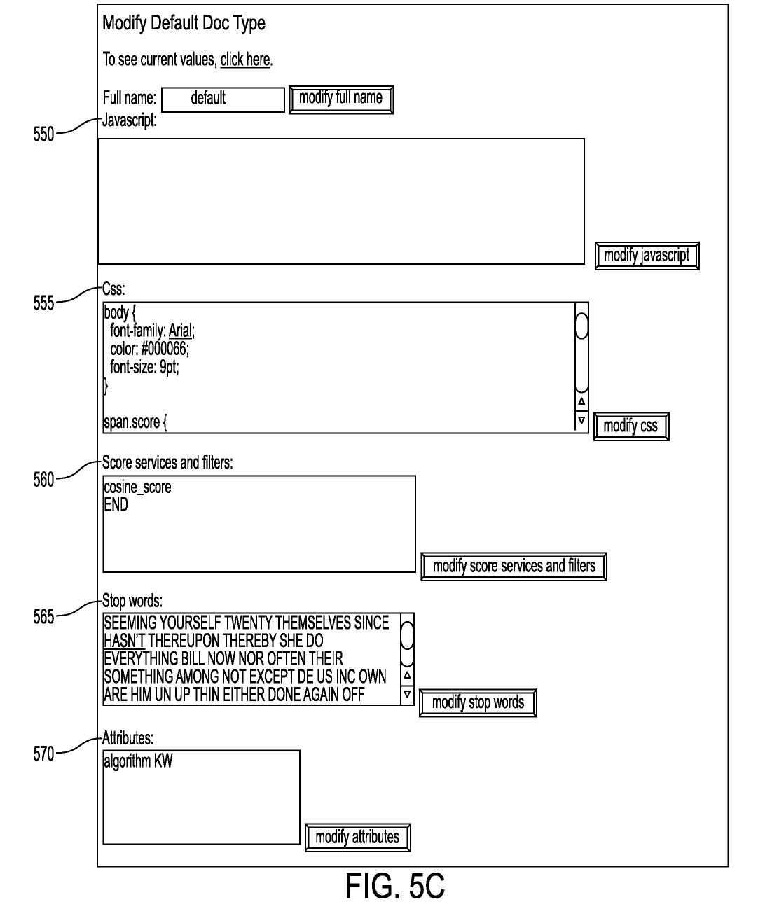

A corpora management interface 116 provides a user interface allowing administration of corpora. A root user interface allows a root administrator responsible for administration of the recommendation system 110 as a whole to perform tasks such as adding new domains, e.g. by specifying a new document type. A corpus administrator interface allows a corpus administrator to perform tasks such as adding new corpora (e.g., by specifying a new document type), specifying which documents should be included within the corpus, specifying when document features and scores should be calculated or recalculated, and the like. Such features are illustrated in more detail with respect to FIGS. 5A-5C.

A corpus recommendation user interface module 117 generates the user interface displaying and allowing interaction with the recommendations for a particular corpus. In one embodiment, the user interface is constructed using a browser-based scripting language such as JavaScript, which can be rendered within a conventional web browser, e.g. as a particular module added by a user to a web page.

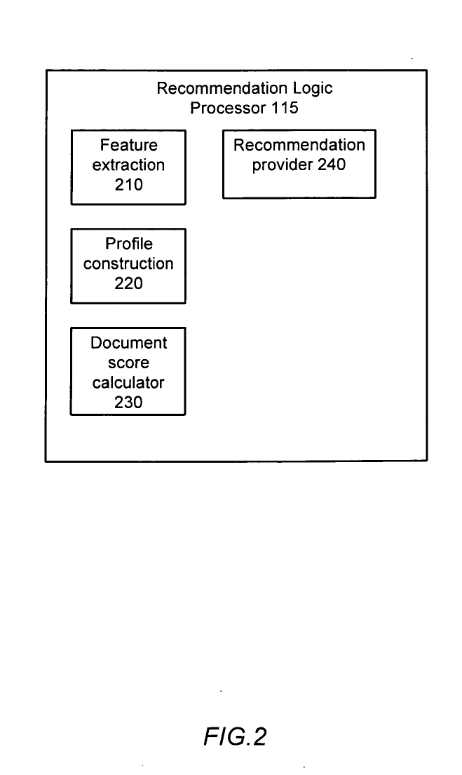

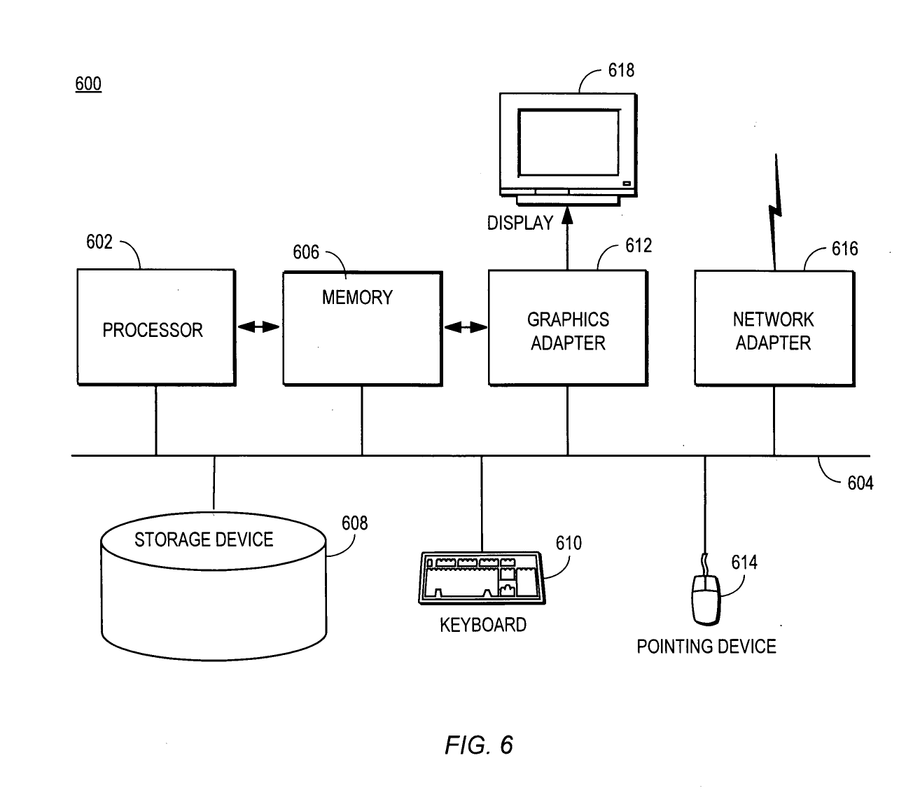

FIG. 2 illustrates in more detail the conceptual components of the recommendation logic processor 115 of FIG. 1. Referring now also to FIG. 6, in an exemplary embodiment recommendation logic processor 115 is, along with other aspects of system 110, implemented by programming a general purpose computer 600. Illustrated are a processor 602 coupled to a bus 604. Also coupled to the bus 604 are a memory 606, a storage device 608, a keyboard 610, a graphics adapter 612, a pointing device 614, and a network adapter 616. A display 618 is coupled to the graphics adapter 612. The processor 602 is in one embodiment any general-purpose processor such as an INTEL x86 compatible-CPU. The memory 606 can be firmware, read-only memory (ROM), non-volatile random access memory (NVRAM), and/or RAM, which holds instructions and data used by the processor 602. The memory 606 may be divided into pages by an operating system of the computer 600, each page having attributes such as whether the page is readable, writable, or executable (i.e. contains executable instructions), or whether it was loaded from a file on the storage device 608. The storage device 608 is, in one embodiment, a hard disk drive but can also be any other device capable of storing data, such as a writeable compact disk (CD) or DVD, a solid-state memory device, or other form of computer-readable storage medium. The storage device 608 stores files and other data structures used by the computer 600.

Referring again back to FIG. 2, a feature extraction module 210 parses documents, assigning features with weights, or scores, according to a weighting algorithm. In an exemplary embodiment, a conventional term-frequency/inverse document frequency (“tf/idf”) weighting algorithm is used, in which each possible term (e.g., the 50,000 useful terms referenced above) is located in the document, and the term's calculated weight is proportional to the number of times the term appears in the document and inversely proportional to the frequency of the word in the corpus. Further detail on document weighting and scoring is found, for example, in commonly owned U.S. Pat. No. 7,383,258 to Georges Harik and Noam Shazeer, entitled “Method and Apparatus for Characterizing Documents Based on Clusters of Related Words.”

In one embodiment, the features and weights extracted automatically by the weighting algorithm are supplemented by additional features and weights associated with the document, such as any tags that the user has associated with the document. The features and weights are then stored in the document features repository 112 in association with an identifier of the document from which they were extracted.

A profile construction module 220 populates the profile features repository 113. In one embodiment, the profile construction module 220 creates an initial profile for a given user based on available data sources. One data source is directory information available within the organization having the domain or corpus of which the user is a member, such as Lightweight Directory Access Protocol (LDAP) information stored on the organization's directory servers, e.g. personnel data available within a company tracking attributes such as age, sex, department, and the like. Another data source is a set of particular non-directory documents associated with the user and stored within the organization, such as a resume of the user or other document indicative of the user's interest areas. Terms are extracted from the document and weighted using the algorithms described above.

Use of these data sources allows the organization to leverage existing information that it stores about the user to produce higher-quality profiles than are created for systems which lack such pre-existing data about the user. In another embodiment, the user explicitly indicates terms of interest, such as by specifying a set of keywords (e.g. “tennis”, “Victorian literature”, etc.). Such explicitly-indicated terms in one embodiment are then assigned a weight higher than the weight of any other non-explicitly-indicated terms, representing the high degree of utility of explicit interests. In one embodiment, the profile construction module 220 additionally updates a user's profile, e.g. based on interactions of the user with documents, such as viewing initially, viewing for some period of time, printing, saving, emailing, explicitly marking the document as favored or disfavored using a user interface, and the like. For example, if a user is provided with a set of recommended documents and views a document having given terms, the value of those terms within the user's profile within the profiles feature repository 113 can be increased by an appropriate amount. In one embodiment, the effect of an interaction on the value of terms within the profile may decrease over time as the interaction ages. In one embodiment, the particular interaction triggering the update of the profile term value leads to different profile update actions. In an example, viewing of the document leads to a lesser increase in the value than printing the document, an action that presumably indicates more serious interest on the part of the user than does viewing. As another example, marking a document as disfavored leads not merely to reducing the values in the user profile for the terms within the document, but also to removing that article, possibly permanently, from any recommendations later provided to that user.

A document score calculator 230 calculates a score for a given document with respect to a given user based on a correlation between the feature weights generated by the feature extraction module 210 and the profiles generated by the profile construction module 220. In one embodiment, the correlation algorithm is a conventional cosine similarity algorithm, which calculates the cosine of e.g. tf-idf vectors of terms for the user's profile and for the document being scored. In another embodiment, the document scores are not calculated independently of each other, but rather influence each other. In one example, a document scoring algorithm is designed to spread knowledge throughout the organization by recommending every document of the corpus to at least one user of the corpus. Such an approach is useful for avoiding institutional knowledge gaps that can come to exist for reasons such as employee attrition. This algorithm addresses an optimization problem in which the goal is to maximize the standard correlation measure matches between users and documents and to minimize the overlap (or maximize the completeness) of the coverage of all the documents in the corpus by the employees. The scores are calculated with respect to all of the users of the corpus at once through conjugate gradient, Monte Carlo, or other optimization techniques. In some embodiments, a number of algorithms are available, and the choice of which particular algorithm to use for a given corpus is made by the corpus administrator via the corpora management interface 116. The document scores are then stored in the document scores repository 114 in association with an identifier of the user and the document to which they correspond.

### Method of Operation

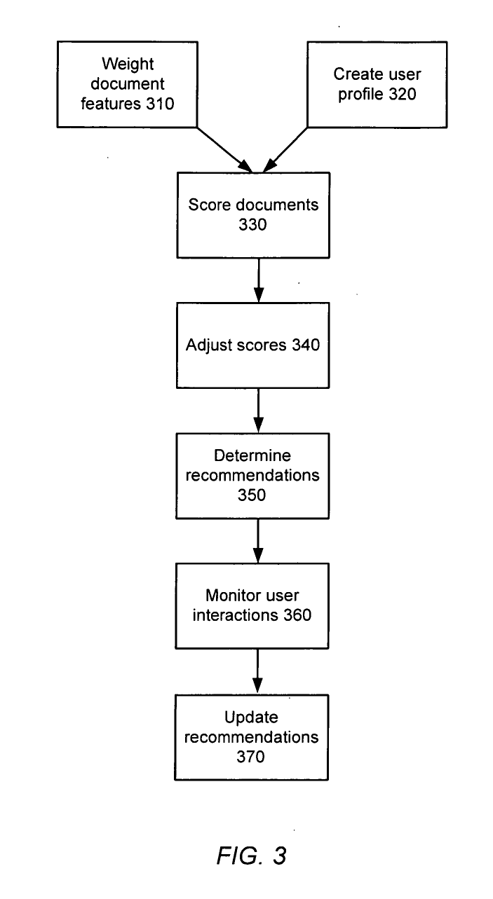

FIG. 3 is a flowchart illustrating the process of providing recommendations, according to one embodiment. At step 310, document features of documents in the corpus are weighted, such as by the feature extraction module 210. As discussed above, this entails, for each document, assigning weights, or scores, to the document features according to a weighting algorithm. One conventional weighting algorithm is term-frequency/inverse document frequency (“tf/idf”). In one embodiment, the features and weights extracted automatically by the above algorithms are supplemented by additional features and weights associated with the document, such as user-defined tags. The features and weights are then stored in the document features repository 112.

At step 320, which may be performed before, in parallel with, or after step 310, an initial profile is created for a user, as described above with respect to the profile construction module of FIG. 2.

At step 330, documents from corpora 130 are scored by the document score calculator 230 as described above with respect to FIG. 2. In one embodiment the scoring is initiated manually, e.g. through a user interface provided by corpora management interface 116; in another embodiment scoring is initiated at scheduled intervals, such as through a Unix “cron” process or other form of scheduled task.

At step 340, the document scores are adjusted as desired based on the current context and the document features. A number of different adjustment rules may be used, and in one embodiment are specified by the corpus administrator via the corpora management interface 150. For example, one adjustment rule biases the score in favor of more recent documents, e.g. by calculating an amount of time between a date of the document (e.g., a creation or modification date) and a set date, increasing the score as a function of the calculated amount of time if the document date is after the set date, and decreasing it otherwise. Adjustment of scores based on document recency can also be accomplished via exponential decay according to a specified document half-life. Another rule biases the score based on the document type or the document itself, e.g. specifying a multiplier value for the score of documents of type “tech talk”, or for a specified “tech talk” document deemed (e.g., by the corpus administrator) to be of particular interest. Still another rule increases the weight of documents that are specific to a user's organization (e.g., company) and increases the weight yet further for documents that are specific to the department or unit of the organization in which the user works. Such rules can also be used to limit the number of results, e.g. through a specified maximum number of results or through a specified minimum score (i.e., a threshold).

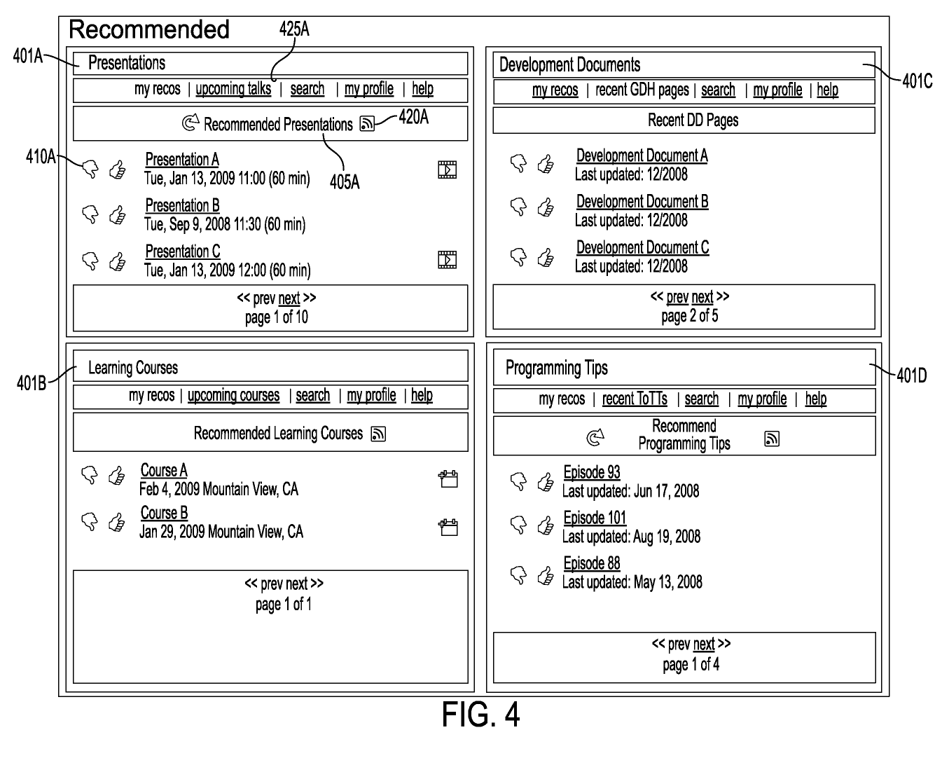

At step 350, recommendations for a particular user are determined by the recommendation provider module 240, as described above. They are then provided to the user. In one example, the results are displayed within the user interface provided by the corpus recommendation UI, such as the corpus recommendation user interfaces discussed with respect to FIG. 4, below. In another example, the recommendations are emailed to the user. In still another example, the recommendations are provided as an RSS feed and displayed within an RSS viewer whenever a new recommendation is added to the list.

At step 360, the user's interactions with documents are monitored. As previously described, different interactions with a document could indicate an interest level of the user in the document, such as viewing, printing, emailing, saving, explicitly marking as favored or disfavored, and the like.

At step 370, if the user interactions monitored at step 360 result in a modification of the user's profile, then the recommendations for that user are likewise updated.

FIG. 4 illustrates a user interface for displaying and interacting with recommendations. Displayed are user interfaces representing recommendations for four corpora, 401A-401D. Each has a title 405A and a set of recommended documents such as 410A. Recommended document 410 has associated “thumbs up” and “thumbs down” icons which the user may select to indicate interest or lack of interest in the article, which are used to update the user profile as described above with respect to profile construction module 220. Each also has an options bar, e.g., 425A, which lists various options associated with the corpus. A corpus recommendation user interface 401A also provides options such as RSS icon 420A, which causes changes to recommendations to be delivered to a news reader of the subscriber via the RSS protocol.

A user interface such as that of FIG. 4 displays all of the corpus recommendation user interfaces 401 associated with a user. Alternatively, individual corpus recommendation user interfaces 401 can be individually embedded within other user interfaces. For example, a web site could support the use of such corpus recommendation user interfaces 401 by allowing a user to select one or more corpus recommendation user interfaces of interest to be embedded in a user's personal home page, for example, and subsequent accesses of that home page by the user could fetch the user interface from the corpus recommendation user interface module 117 of the recommendation system 110.

FIGS. 5A-D illustrate user interfaces for administration of various aspects of the recommendation system 110 of FIG. 1. FIG. 5A illustrates a user interface for a root administrator. User interface area 505 allows a root administrator using the interface to grant rights to the root domain to another user. User interface area 510 allows the root administrator to make a user an administrator of a given domain. That user will then have permissions to administer that domain as described in FIG. 5B, below. User interface area 515 allows the root administrator to create a new domain, and individual corpora can then be associated with that domain, e.g. by an administrator for the domain. Finally, user interface area 520 allows the root administrator to see a list of all the domains that have been created for the recommendation system 110.

FIG. 5B illustrates a user interface for an administrator of one of the domains. User interface area 530 allows the domain administrator to add a new corpus to the domain, optionally specifying both a full name of the domain (e.g., “Network Security Forum”) and a short name (e.g., “Net. SF”) for use in areas of user interfaces of the recommendation system in which compact names are useful. User interface area 535 allows the domain administrator to grant corpus administration privileges to another user of the system for one of the corpora in the domain—in the illustrated example, the corpus named “Jobs.” User interface area 540 allows the domain administrator to make another user of the system an administrator of the same domain.

FIG. 5C illustrates a user interface for a domain administrator for setting the default attributes for any corpus in that domain. An equivalent interface is used by an administrator of a specific corpus to define behavior of the recommendation and presentation of the documents in the corpus. User interface area 540 allows the corpus administrator to specify Javascript code to define the user interface of the corpus recommendation as desired. For example, the corpus administrator could write code to add menu items, links, etc. to the user interface of the corpus recommendation user interface, such as the link bar 425A of FIG. 4. User interface area 555 allows the corpus administrator to specify Cascading Style Sheet (CSS) code to control visual aspects such as how the document link text is displayed (9 point Arial font in the illustrated example). User interface area 560 allows the corpus administrator to specify which scoring algorithms and score adjustment filters to employ when computing scores for documents in the corpus. User interface area 565 allows the corpus administrator to specify “stop words”, i.e., words that will be ignored when scoring the documents in the corpus. Finally, user interface area 570 allows the corpus administrator to specify attributes of the corpus, such as the algorithm used to weight document features (e.g., “KW” in this example, which refers to the tf-idf, or “keyword”, algorithm).

It is appreciated that methods carrying out the above-described steps need not include the exact steps, formulas, or algorithms disclosed above, nor need they be in the same precise order. Rather, variations on the scope and functionality of the individual steps, and on the order thereof, are possible while still accomplishing the aims of the present invention.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the words “a” or “an” are employed to describe elements and components of the invention. This is done merely for convenience and to give a general sense of the invention. This description should be read to include one or at least one and the singular also includes the plural unless it is obvious that it is meant otherwise.

Certain aspects of the present invention include process steps and instructions described herein in the form of a method. It should be noted that the process steps and instructions of the present invention could be embodied in software, firmware or hardware, and when embodied in software, could be downloaded to reside on and be operated from different platforms used by real time network operating systems.

The present invention also relates to a system for performing the operations herein. This system may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Upon reading this disclosure, those of skill in the art will appreciate that still additional alternative structural and functional designs are possible. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A computer-implemented method comprising:
determining, by a processor, a set of weighted features for each of a plurality of documents;
generating, by the processor, a first score for each of the plurality of documents based on the set of weighted features;
receiving, by the processor, a user profile for a user,
the user profile including information associated with one or more terms of interest that are specific to the user and provided by the user;
adjusting, by the processor, the first score based on correlation between the set of weighted features and the user profile;
providing, for presentation and by the processor, information regarding documents, of the plurality of documents, based on the adjusted first score;
determining, by the processor, different user interactions with information regarding a set of the documents;
updating, by the processor, the user profile based on the different user interactions,
each different user interaction, of the different user interactions, updating a respective value associated with the user profile,
a first user interaction, of the different user interactions, indicating a first level of interest of the user, the first user interaction being a given one of: printing, saving, emailing, explicitly marking as favored, or explicitly marking as disfavored, and the first user interaction causing the respective value to be updated by a different amount than caused by a second user interaction, of the different user interactions, the second user interaction indicating a second level of interest of the user, and
the respective value being adjusted based on an amount of time from when the first user interaction occurs, the amount of time indicating an age of the given one of: the printing, the saving, the emailing, the explicitly marking as favored, or the explicitly marking as disfavored, wherein an effect of the first user interaction on adjustment of the respective value decreases over time as the age increases; and
generating, by the processor, a second score, for the set of documents based on correlation between the set of weighted features and the updated user profile,
information regarding the set of documents being provided based on the second score.

2. The computer-implemented method of claim 1, further comprising:
determining the user profile from at least one of:
one or more interest areas of the user,
one or more interests indicated by the user, or
one or more interest areas derived from one or more prior user selections.

3. The computer-implemented method of claim 1, where the user profile includes at least one of:
one or more resumes associated with the user, or
one or more business plans associated with the user.

4. The computer-implemented method of claim 1, where each of the plurality of documents are associated with an organization, and the user profile is stored by the organization.

5. The computer-implemented method of claim 2, where the one or more interest areas derived from one or more prior user selections are determined using one or more weighted features associated with one or more documents previously accessed by the user.

6. The computer-implemented method of claim 2, where the one or more interest areas derived from one or more prior user selections are determined using one or more weighted features associated with one or more documents previously accessed by one or more other users.

7. The computer-implemented method of claim 1, where the adjusting includes determining, from one or more user activities, a set of other users that are related to the user.

8. The computer-implemented method of claim 1, where each of the plurality of documents is associated with an organization, the method further comprising:
weighting at least one of the documents based on a measure of importance of the document with respect to the organization.

9. (canceled)

10. The computer-implemented method of claim 1, where the first score for each of the plurality of documents is adjusted based on weighting an amount of time between a respective date of each of the plurality of documents and a predetermined date.

11. The computer-implemented method of claim 10, where the first score decreases based on a respective characteristic of each of the plurality of documents.

12. The computer-implemented method of claim 1, further comprising:
providing, for presentation, a plurality of user interfaces for receiving information from the user, where each of the plurality of user interfaces is associated with a different set of attributes.

13. (canceled)

14. The computer-implemented method of claim 1, where the set of weighted features for each of the plurality of documents is determined using one or more settings specified by an administrator of a corpus that includes the plurality of documents.

15. The computer-implemented method of claim 1, where the first score is adjusted using one or more settings specified by at least one of the user or an administrator of a corpus that includes the plurality of documents.

16. The computer-implemented method of claim 1, where the information regarding one or more documents, of the plurality of documents, is provided, for presentation, to the user in a user interface specified by at least one of the user or an administrator of a corpus that includes the plurality of documents.

17. (canceled)

18. A device comprising:
a memory to store instructions; and
a processor to execute the instructions to:
determine a set of weighted features for each of a plurality of documents;
generate a first score for each of the plurality of documents based on the set of weighted features;
receive a user profile for a user,
the user profile including information associated with one or more terms of interest that are specific to the user and provided by the user;
adjust the first score based on correlation between the set of weighted features and the user profile;
provide, for presentation, information regarding documents, of the plurality of documents, based on the adjusted first score;
determine different user interactions with information regarding a set of the documents;
update the user profile based on the different user interactions,
each different user interaction, of the different user interactions, updating a respective value associated with the user profile,
a first user interaction, of the different user interactions, indicating a first level of interest of the user, the first user interaction being a given one of: printing, saving, emailing, explicitly marking as favored, or explicitly marking as disfavored, and the first user interaction causing the respective value to be updated by a different amount than caused by a second user interaction, of the different user interactions, the second user interaction indicating a second level of interest of the user, and
the respective value being adjusted based on an amount of time from when the first user interaction occurs, the amount of time indicating an age of the given one of: the printing, the saving, the emailing, the explicitly marking as favored, or the explicitly marking as disfavored, wherein an effect of the first user interaction on adjustment of the respective value decreases over time as the age increases;
generate a second score for the set of documents based on correlation between the set of weighted features and the updated user profile,
information regarding the set of documents being provided based on the second score.

19. The device of claim 18, where the processor is further to:
determine the user profile from at least one of:
one or more interest areas of the user,
one or more interests indicated by the user, or
one or more interest areas derived from one or more prior user selections.

20. The device of claim 18, where the user profile includes at least one of:
one or more resumes associated with the user, or one or more business plans associated with the user.

21. The device of claim 18, where each of the plurality of documents are associated with an organization, and the user profile is stored by the organization.

22. The device of claim 19, where the processor is further to:
determine that the one or more interest areas are derived from one or more prior user selections using one or more weighted features associated with one or more documents previously accessed by the user.

23. The device of claim 19, where the processor is further to:
determine that the one or more interest areas are derived from one or more prior user selections using one or more weighted features associated with one or more documents previously accessed by one or more other users.

24. The device of claim 18, where, when adjusting the first score, the processor is to:
determine, from one or more user activities, a set of other users that are related to the user.

25. The device of claim 18, where each of the plurality of documents is associated with an organization, and the processor is further to:
weight at least one of the documents based on a measure of importance of the document with respect to the organization.

26. (canceled)

27. The device of claim 18, where the processor is further to: adjust the first score for each of the plurality of documents based on weighting an amount of time between a respective date of each of the plurality of documents and a predetermined date.

28. The device of claim 27, where the processor is further to: decrease the first score based on a respective characteristic of each of the plurality of documents.

29. The device of claim 18, where the processor is further to: provide, for presentation, a plurality of user interfaces for receiving information from the user, where each of the plurality of user interfaces is associated with a different set of attributes.

30. A non-transitory computer-readable storage medium storing instructions, the instructions comprising:
one or more instructions which, when executed by at least one processor, cause the at least one processor to determine a set of weighted features for each of a plurality of documents;
one or more instructions which, when executed by the at least one processor, cause the at least one processor to generate a first score for each of the plurality of the documents based on the set of weighted features;
one or more instructions which, when executed by the at least one processor, cause the at least one processor to receive a user profile for a user,
the user profile including information associated with one or more terms of interest that are specific to the user and provided by the user;
one or more instructions which, when executed by the at least one processor, cause the at least one processor to adjust the first score based on correlation between the set of weighted features and the user profile;
one or more instructions which, when executed by the at least one processor, cause the at least one processor to provide, for presentation, information regarding documents, of the plurality of documents, based on the adjusted first score;
one or more instructions which, when executed by the at least one processor, cause the at least one processor to determine different user interactions with information regarding a set of the documents;
one or more instructions which, when executed by the at least one processor, cause the at least one processor to update the user profile based on the different user interactions, each different user interaction, of the different user interactions, updating a respective value associated with the user profile,
a first user interaction, of the different user interactions, indicating a first level of interest of the user, the first user interaction being a given one of: printing, saving, emailing, explicitly marking as favored, or explicitly marking as disfavored, and the first user interaction causing the respective value to be updated by a different amount than caused by a second user interaction, of the different user interactions, the second user interaction indicating a second level of interest of the user, and
the respective value being adjusted based on an amount of time from when the first user interaction occurs, the amount of time indicating an age of the given one of: the printing, the saving, the emailing, the explicitly marking as favored, or the explicitly marking as disfavored, wherein an effect of the first user interaction on adjustment of the respective value decreases over time as the age increases; and
one or more instructions which, when executed by the at least one processor, cause the at least one processor to generate a second score for the set of documents based on correlation between the set of weighted features and the updated user profile,
information regarding the set documents being provided based on the second score.

31. The medium of claim 30, where the instructions further comprise:
one or more instructions to determine the user profile from at least one of:
one or more interest areas of the user,
one or more interests indicated by the user, or
one or more interest areas derived from one or more prior user selections.

32. The medium of claim 30, where the user profile includes at least one of:
one or more resumes associated with the user, or
one or more business plans associated with the user.

33. The medium of claim 30, where each of the plurality of documents are associated with an organization, and the user profile is stored by the organization.

34. The medium of claim 31, where the instructions further comprise:
one or more instructions to determine that the one or more interest areas are derived from one or more prior user selections using one or more weighted features associated with one or more documents previously accessed by the user.

35. The medium of claim 31, where the instructions further comprise:
one or more instructions to determine that the one or more interest areas are derived from one or more prior user selections using one or more weighted features associated with one or more documents previously accessed by one or more other users.

36. The medium of claim 30, where the one or more instructions to adjust the first score include:
one or more instructions to determine, from one or more user activities, a set of other users that are related to the user.

37. The medium of claim 30, where each of the plurality of documents are associated with an organization, the instructions further comprising:
one or more instructions to weight at least one of the documents based on a measure of importance of the document with respect to the organization.

38. (canceled)

39. The medium of claim 30, where the one or more instructions to adjust the first score include:
one or more instructions to adjust the first score based on weighting an amount of time between a respective date of each of the plurality of documents and a predetermined date.

40. The medium of claim 39, where the instructions further comprise:
one or more instructions to decrease the first score based on a respective characteristic of each of the plurality of documents.

41. (canceled)

42. The medium of claim 30, where the instructions further comprise:
one or more instructions to provide, for presentation, a plurality of user interfaces for receiving information from the user, where each of the plurality of user interfaces is associated with a different set of attributes.

43-48. (canceled)

49. The computer-implemented method of claim 48, wherein the second user interaction is not the given one, but is another one of: the printing, the saving, the emailing, the explicitly marking as favored, or the explicitly marking as disfavored.

50. The computer-implemented method of claim 1, wherein adjusting the first score comprises adjusting the first score based at least in part on one or more specified rules.

51. The computer-implemented method of claim 50, wherein the one or more specified rules include a rule that biases the first score based on a document type of each of the plurality of documents.

52. The computer-implemented method of claim 1, wherein the adjusting the first score based on the correlation between the weighted features and the user profile comprises adjusting based on correlation between the weighted features and the terms of interest that are specific to the user.
